(19) United States
(12) Patent Application Publication
(10) Pub. No.: US 2022/0289923 A1
(43) Pub. Date: Sep. 15, 2022

(54) FLAT MATERIAL, SANDWICH MATERIAL, ELECTROCHEMICAL STORAGE UNIT, AND METHOD FOR PRODUCING A FLAT MATERIAL

(71) Applicant: ElringKlinger AG, Dettingen (DE)

(72) Inventors: Robert WITZGALL, Reutlingen (DE); Joachim SENGBUSCH, Dettighofen (DE); Harri DITTMAR, Grünenbach (DE)

(73) Assignee: ElringKlinger AG, Dettingen (DE)

(21) Appl. No.: 17/832,497

(22) Filed: Jun. 3, 2022

Related U.S. Application Data
(63) Continuation of application No. PCT/EP2020/085225, filed on Dec. 9, 2020.

(30) Foreign Application Priority Data
Dec. 13, 2019 (DE) 10 2019 219 594.6

(51) Int. Cl. C08J 5/24; C08J 5/04; C08K 7/14

(52) U.S. Cl. CPC C08J 5/244; C08J 5/043; C08K 7/14; C08J 2323/12

(57) ABSTRACT

The aim of the invention is to provide a flat material that is as stable as possible and can be produced as easily as possible. According to the invention, this is achieved in that the flat material comprises a thermoplastic polymer matrix material in which a fiber material is received, wherein the fiber material comprises fibers or is made of fibers that are arranged at least approximately parallel to one another, and the proportion of the fiber material to the flat material equals approximately 75 wt. % or more, based on the total mass of the flat material.

### RELATED APPLICATION

This application is a continuation of international application No. PCT/EP2020/085225 filed on Dec. 9, 2020, and claims the benefit of German application No. 10 2019 219 594.6 filed on Dec. 13, 2019, which are incorporated herein by reference in their entirety and for all purposes.

### FIELD OF DISCLOSURE AND BACKGROUND

The present invention relates to a flat material, in particular for use in sandwich materials in vehicles and/or electrochemical storage units.

Furthermore, the present invention relates to a sandwich material, in particular for use as a load-bearing element in a vehicle and/or in a receiving element of an electrochemical storage unit.

The present invention also relates to an electrochemical storage unit.

The present invention also relates to a method for producing a flat material.

### SUMMARY OF THE INVENTION

The object of the present invention is to provide a flat material that is as stable as possible and can be produced as easily as possible.

According to the invention, this problem is solved by the flat material according to Claim 1.

The flat material is in particular suitable for use in sandwich materials in vehicles and/or in electrochemical storage units.

The flat material preferably comprises a polymer matrix material, in particular a thermoplastic polymer matrix material, in which a fiber material is received.

The fiber material comprises fibers or is made of fibers that are arranged at least approximately parallel to one another.

A proportion of the fiber material to the flat material is preferably approximately 75 wt. % or more, based on a total mass of the flat material.

Due to the high proportion of the fiber material, the flat material preferably has increased stiffness and/or increased resistance to bending and/or increased impact properties compared to flat materials having a lower proportion of fiber material.

In particular, the flat material is more stable and/or more resistant to heat and/or fire compared to flat materials having a lower proportion of fiber material.

The flat material preferably has a reduced thermal conductivity compared to flat materials having a lower proportion of fiber material.

The flat material is preferably a material whose extent in two spatial directions is greater by a factor of 50 or more, in particular by a factor of 100 or more, for example by a factor of 1000 or more, than the extent of the flat material in the third spatial direction.

For example, the flat material is a band material and/or a tape material.

The flat material preferably forms a stabilization and/or protective material.

The flat material preferably forms a unidirectional flat material.

A predominant part of the fibers of the fiber material is preferably arranged at least approximately parallel to one another and/or at least approximately parallel to a main extension plane of the flat material.

Approximately 80% of the fibers of the fiber material or more, in particular approximately 90% of the fibers of the fiber material or more, are preferably arranged at least approximately parallel to one another.

An orientation of the fibers is preferably determined by means of electron microscopy and in particular by means of subsequent image processing.

As an alternative to a thermoplastic polymer matrix material, it can be provided that the polymer matrix material is an elastomeric polymer matrix material or a thermosetting polymer matrix material.

It can also be provided that the polymer matrix material is a thermoplastic elastomeric polymer matrix material or a thermosetting elastomeric polymer matrix material or a thermoplastic duromeric polymer matrix material.

Preferably, the thermoplastic polymer matrix material is a polyolefin material, in particular a polypropylene material, for example polypropylene.

It can be favorable if the thermoplastic polymer matrix material is made of a thermoplastic polymer material.

The polymer material is preferably a thermoplastic polymer material.

Alternatively, it can be provided that the polymer matrix material is made of an elastomeric polymer material or a thermosetting polymer material.

According to further alternatives, the polymer matrix material is made of a thermoplastic elastomeric polymer material or a thermosetting elastomeric polymer material or a thermoplastic thermosetting polymer material.

It can be favorable if a low-viscosity thermoplastic polymer material is used as the thermoplastic polymer material.

In particular, the thermoplastic polymer material from which the polymer matrix material is made is a polyolefin material, in particular a polypropylene material, for example polypropylene.

It can be favorable if the thermoplastic polymer material comprises a curing agent and/or a reaction accelerator. These preferably serve to optimize and/or accelerate a curing reaction.

The polymer matrix material and the polymer material are preferably chemically and/or physically identical.

Preferably, the thermoplastic polymer matrix material is made of a thermoplastic polymer material having a melt flow index of approximately 400 (g/10 min) or greater.

The melt flow index is preferably determined according to the DIN EN ISO 1133 standard.

It can be favorable if the melt flow index is determined by means of a capillary rheometer. A material to be tested, in this case the thermoplastic polymer material, is melted in a heatable cylinder, for example, and is pressed through a defined nozzle, for example a capillary, under a pressure created by a bearing load. An exiting volume or an exiting mass of the melt of the polymer material is then preferably determined as a function of time. The exiting melt of the polymer material is also called an extrudate.

The values given above and below for the melt flow index are preferably based on measurements of the melt flow index that were carried out at a test temperature of approximately 190° C. and a bearing load of approximately 5 kg.

It can be advantageous if the melt flow index of the thermoplastic polymer material is approximately 700 (g/10 min) or more, in particular approximately 1200 (g/10 min) or more.

Preferably, the melt flow index of the thermoplastic polymer material is approximately 1400 (g/10 min) or less, in particular approximately 1300 (g/10 min) or less.

Polymer materials having the aforementioned comparatively high melt flow indices preferably have a sufficiently low viscosity to wet comparatively high proportions of fiber material in the flat material sufficiently well.

It can be advantageous if the fiber material is embedded, in particular completely, in the thermoplastic polymer material and/or the thermoplastic polymer matrix material.

A material bond is preferably formed between the fiber material and the thermoplastic polymer material and/or between the fiber material and the thermoplastic polymer matrix material.

For example, the thermoplastic polymer material and/or the thermoplastic polymer matrix material adheres to the fibers of the fiber material.

It can be favorable if a proportion of the fiber material to the flat material is approximately 78 wt. % or more, in particular approximately 80 wt. % or more. The proportion of fiber material is preferably related to a total mass of the flat material.

The proportion of the fiber material to the flat material is preferably approximately 90 wt. % or less, in particular approximately 85 wt. % or less, for example approximately 82 wt. % or less, based on the total mass of the flat material.

It can be favorable if the proportion of fiber material to the flat material is approximately 40 vol. % or more, in particular approximately 50 vol. % or more, for example approximately 60 vol. % or more, based on a total volume of the flat material.

In particular, the proportion of fiber material to the flat material is approximately 70 vol. % or less, in particular approximately 65 vol. % or less, for example approximately 62 vol. % or less, based on the total volume of the flat material.

As a result of the proportions of fiber material mentioned, the flat material preferably has increased impact properties in comparison to flat materials having lower fiber proportions.

The thermoplastic polymer matrix material preferably functions as a fixation for the fiber material.

The fiber material preferably dominates one or more of the following properties of the fiber material:
a stiffness of the flat material; and/or
a strength of the flat material and/or
an energy absorption of the flat material.

It can be provided that the flat material has a thickness of approximately 5 mm or less, in particular approximately 4 mm or less, for example approximately 3 mm or less, perpendicular to the main extension plane thereof.

The thickness of the flat material perpendicular to the main extension plane thereof is preferably approximately 0.5 mm or more, in particular approximately 1 mm or more, for example approximately 1.2 mm or more.

It can be favorable if the flat material has increased temperature resistance. In particular, temperature resistance of the mechanical properties of the flat material is optimized.

In particular, due to the stated proportions of the fiber material to the flat material, the flat material has a modulus of elasticity, in particular at approximately 20° C., preferably at approximately 41 GPa or more, in particular at around approximately 44 GPa or more.

The modulus of elasticity of the flat material, in particular at approximately 20° C., is preferably approximately 50 GPa or less, in particular approximately 47 GPa or less.

The modulus of elasticity is preferably determined in the fiber direction.

This preferably results in increased stiffness, in particular increased structural stiffness, of the flat material.

The flat material preferably has an increased moment of resistance to bending in comparison to metallic components having comparable dimensions.

The flat material can preferably be produced by means of existing production processes, in particular without a production process having to be changed.

It can be advantageous if the fiber material is a continuous fiber material. Continuous fiber materials can preferably be incorporated into a thermoplastic polymer matrix material that is relatively brittle.

A “continuous fiber material” is preferably a fiber material in which 90% or more, in particular 95% or more, of the fibers have a length of approximately 50 mm or more, preferably approximately 1000 mm or more.

For example, the fiber material comprises glass fibers or is made of glass fibers.

It can be provided that the flat material is made of the fiber material pre-impregnated with the polymer material, the fiber material being in particular completely impregnated with polymer material.

The polymeric material here is preferably a thermoplastic polymer material.

As a result of the pre-impregnation, “prepregs” in particular can be used to produce the flat material or can form the flat material.

The “prepregs” are cured, for example, in a curing reaction at an elevated pressure and/or an elevated temperature, a crosslinking reaction of molecules of the polymer material taking place, for example. Here, for example, the thermoplastic polymer matrix material is formed.

Alternatively, it can be provided that no curing reaction is carried out.

Preferably, the flat material is fire resistant and/or flame resistant, in particular for approximately 130 seconds or more and/or at a flame temperature in a range of approximately 700° C. and approximately 800° C.

Preferably, in a fire test, for example a fire test according to ECE180, only a surface layer and/or a surface film of the flat material used in a sandwich material burns off when exposed to flames for about 130 seconds, in particular with premium-grade gasoline.

Approx. 130 seconds is preferably an evacuation time that remains in the event of a fire in a vehicle in order to rescue vehicle occupants.

In the fire test, a mixed accident of an internal combustion engine vehicle and/or a battery electric car and/or a plug-in hybrid vehicle and/or a hydrogen-powered vehicle is preferably simulated.

In the fire test, for example, a test plate is used as the bottom wall of a receiving element of an electrochemical storage unit. The test plate preferably has dimensions of approximately 695 mm×approximately 695 mm.

The receiving element preferably forms a simulated battery box.

It can be provided that a frame of the receiving element is made of aluminum.

In particular, a cover element of the receiving element is made of plaster in the fire test.

During the fire test, the fuel, for example premium-grade gasoline, is preferably provided in a fire pan, which is placed under the test plate in particular and remains there for approximately 70 seconds in particular.

In order to set a constant flame temperature of approximately 700° C. to approximately 800° C., the fuel preferably burns for approximately 60 seconds before the test plate is flamed.

A stone grate is then preferably positioned near the test plate for approximately 60 seconds, in particular to simulate a chimney effect.

The test plate is preferably made of a sandwich material. In the case of the sandwich material, a first layer element and a second layer element, which form cover layers, for example, are preferably produced from a flat material. The flat material preferably has a thickness of approximately 1.5 mm perpendicular to its main extension plane.

The flat material used in the test plate preferably has a fiber material content of approximately 80 wt. %, based on the total mass of the flat material. The polymer material from which the thermoplastic polymer matrix material is made is preferably a polypropylene material having a melt flow index of about 1200 (g/10 min).

After the fire test, the test plate is preferably substantially intact and/or retains its shape.

A loss in mass of the test plate is preferably approximately 14 g or less.

The loss of mass is in particular so low because little or no oxygen can penetrate deeper into the flat material due to the high proportion of fiber material.

Preferably, the test plate made of the sandwich material does not burn through and/or does not experience a structural failure.

In particular, a temperature on an interior space of the test plate facing an inner side of the receiving element is not critical for elements arranged in the interior space.

The temperature on the inner side of the sandwich material is preferably approximately 99° C. or less, for example after approximately 130 seconds of flaming.

The invention also relates to a sandwich material, in particular for use as a load-bearing element in a vehicle and/or in a receiving element of an electrochemical storage unit.

The sandwich material preferably forms a bulletproof protective plate.

The sandwich material preferably comprises a first layer element, a second layer element and an intermediate layer arranged between the first layer element and the second layer element.

The vehicle can be an electric vehicle and/or a gas vehicle and/or a fuel cell vehicle.

The sandwich material according to the invention preferably has one or more of the features described in connection with the flat material according to the invention and/or one or more of the advantages described in connection with the flat material according to the invention.

The first layer element and/or the second layer element preferably comprise a flat material according to the invention or are made therefrom.

Due to the fact that the first layer element and/or the second layer element comprise or are formed from a flat material, a deformation caused by the action of a force is preferably elastic. For example, no permanent deformations remain in the sandwich material in what is known as a “bollard test.”

Preferably, the sandwich material can also be reused after deformation. In this way, costs that are necessary for a component having aluminum, for example, can be saved.

The first layer element and/or the second layer element are, for example, cover layers of the sandwich material.

The invention further relates to an electrochemical storage unit that comprises one or more electrochemical cells and a receiving element for receiving and/or fastening the one or more electrochemical cells. The receiving element preferably comprises a flat material according to the invention or is made therefrom.

For example, the electrochemical storage unit is a battery module and/or an accumulator module.

The one or more electrochemical cells are preferably lithium-ion battery(s) and/or lithium-ion accumulator(s).

The electrochemical storage unit according to the invention preferably has one or more of the features described in connection with the flat material according to the invention and/or one or more of the advantages described in connection with the flat material according to the invention.

Provision can be made for a cover element of the receiving element, which cover element covers the one or more electrochemical cells on one or more connection elements on the side facing the one or more electrochemical cells, to consist of or comprise a flat material according to the invention.

Additionally or alternatively, one or more sidewalls and/or a bottom wall of the receiving element comprise or are made of a flat material according to the invention.

It can be provided that the flat material is used in a sandwich material in the cover element or as a cover element.

Additionally or alternatively, a sandwich material according to the invention is used in one or more sidewalls of the receiving element or as one or more sidewalls of the receiving element.

In particular, a sandwich material according to the invention is used in the bottom wall of the receiving element or as the bottom wall of the receiving element.

The invention also relates to a method for producing a flat material, in particular a flat material according to the invention.

The method preferably comprises impregnating a fiber material that comprises fibers or is made of fibers that are arranged at least approximately parallel to one another with a polymer material. The polymer material is preferably a thermoplastic polymer material.

A proportion of the fiber material to a resulting flat material is preferably approximately 75 wt. % or more, in particular 78 wt. % or more, based on a total mass of the flat material.

The polymer material is preferably a thermoplastic polymer material whose melt flow index is in particular about 400 (cm³/10 min) or more and/or whose melt flow index is about 400 (g/10 min) or more.

The method according to the invention preferably has one or more of the features described in connection with the flat material according to the invention and/or one or more of the advantages described in connection with the flat material according to the invention.

Further features and/or advantages of the invention are the subject matter of the following description and the drawings illustrating embodiments.

### BRIEF DESCRIPTION OF THE DRAWINGS

FIG. 1 is a schematic representation of a sequence of an embodiment of a method for producing a flat material;

FIG. 2 is a schematic sectional view of an embodiment of a sandwich material comprising a first layer element, a second layer element and an intermediate layer arranged between the first layer element and the second layer element, the first layer element and/or the second layer element being made from the flat material from FIG. 1;

FIG. 3 is a schematic sectional view of an electrochemical storage unit comprising a receiving element, the receiving element comprising a flat material; and

FIG. 4 is a diagram of temperature curves over time in different ranges during a fire test.

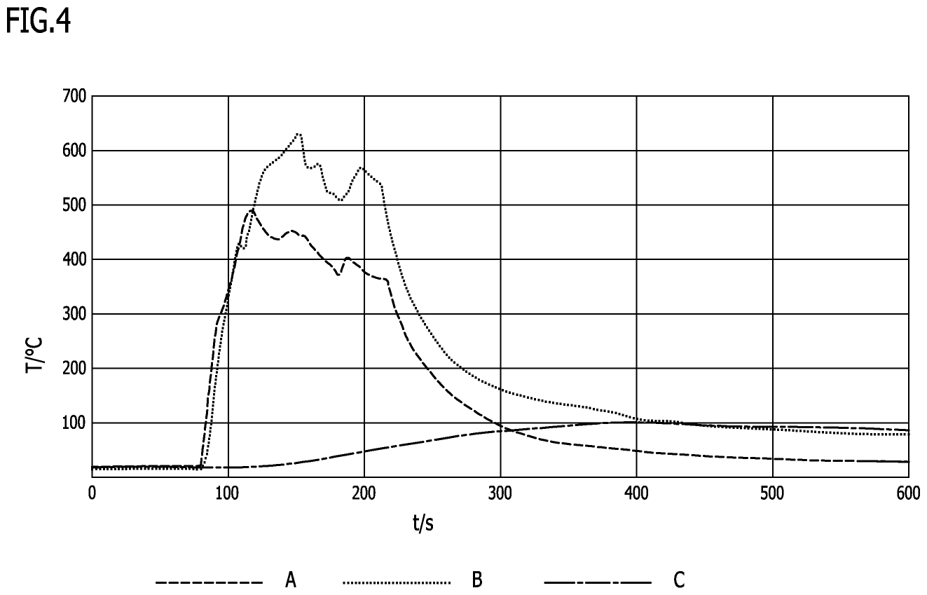

The same or functionally equivalent elements are provided with the same reference signs in all figures.

### DETAILED DESCRIPTION OF THE DRAWINGS

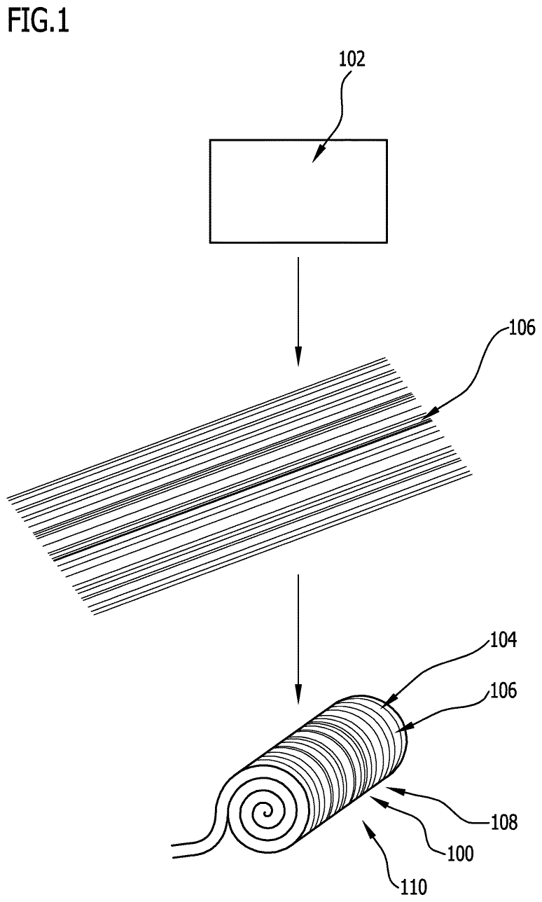

In FIG. 1 a sequence of an embodiment of a method for producing a flat material designated as a whole with 100 is shown schematically.

The flat material 100 is preferably a material whose extent in two spatial directions is greater by a factor of 50 or more, in particular by a factor of 100 or more, for example by a factor of 1000 or more, than the extent of the flat material 100 in the third spatial direction.

A thermoplastic polymer material 102 is preferably provided that forms a thermoplastic polymer matrix material 104 in the flat material 100 in particular.

As an alternative to a thermoplastic polymer material 102, it can be provided that the polymer material 102 is a thermosetting polymer material or an elastomeric polymer material.

Alternatively, a thermoplastic elastomeric polymer material or a thermosetting elastomeric polymer material or a thermoplastic thermosetting polymer material can be used as the polymer material 102.

The thermoplastic polymer matrix material 104 preferably serves as a matrix system in which a fiber material 106 is received.

It can be favorable if the fiber material 106 is integrated into the thermoplastic polymer material 102 and/or is embedded in the thermoplastic polymer material 102.

Preferably, the fiber material 106 is integrated into the thermoplastic polymer matrix material 104 and/or embedded in the thermoplastic polymer matrix material 104.

It can be advantageous if the thermoplastic polymer material 102 wets fibers, in particular all fibers, of the fiber material 106 and/or adheres to the fibers, in particular all fibers, of the fiber material 106.

It can be provided that the thermoplastic polymer material 102 is chemically and/or physically identical to the thermoplastic polymer matrix material 104.

Alternatively, it can be provided that the thermoplastic polymer material 102 reacts chemically, for example during a curing reaction, for example in a crosslinking reaction.

The thermoplastic polymer material 102 preferably comprises a polyolefin material, such as a polypropylene material, or is formed from a polyolefin material, such as a polypropylene material.

It can be favorable if the thermoplastic polymer material 102 comprises a curing agent and/or a reaction accelerator. These preferably serve to optimize and/or accelerate the curing reaction.

The thermoplastic polymer material 102 preferably has a melt flow index of approximately 400 (g/10 min) or more.

It can be favorable if the thermoplastic polymer material 102 has a melt flow index of approximately 700 (g/10 min) or more.

Preferably, the thermoplastic polymer material 102 has a melt flow index of approximately 1200 (g/10 min) or more.

With such high melt flow indices, the thermoplastic polymer material 102 preferably has a sufficiently low viscosity to wet the fiber material 106, in particular completely.

The melt flow index is preferably determined according to DIN EN ISO 1133. The DIN EN ISO 1133 standard is a standard for determining the melt flow index of thermoplastics.

For example, the melt flow index is determined using a capillary rheometer.

The determination of the melt flow index is preferably carried out at a test temperature of approximately 190° C. and a bearing load of approximately 5 kg.

It can be advantageous if a polypropylene material, for example polypropylene, having one of the aforementioned melt flow indices is used as the thermoplastic polymer material 102.

It can be favorable if the fiber material 106 is impregnated with the polymer material 102.

For example, so-called “prepregs” are produced.

In the case of the prepregs, the thermoplastic polymer material 102 is preferably cured and/or crosslinked in a curing reaction before and/or during assembly. The curing reaction preferably takes place at an elevated pressure and/or an elevated temperature.

Alternatively, the fiber material 106 impregnated with the thermoplastic polymer material 102 can also be used directly as the flat material 100 without a curing reaction.

A continuous fiber material is preferably used as the fiber material 106, in which continuous fiber material approximately 90% of the fibers or more have a length of approximately 50 mm or more, preferably approximately 1000 mm or more.

Preferably, approximately 95% of the fibers of the fiber material 106 or more have a length of approximately 50 mm or more, in particular approximately 1000 mm or more.

For example, approximately 98% of the fibers of the fiber material 106 or more have a length of approximately 50 mm or more, in particular approximately 1000 mm or more.

By using a continuous fiber material, the thermoplastic polymer material 102 is preferably used exclusively to fix the fiber material 106.

A fiber material 106 is preferably used that comprises fibers or is made of fibers that are arranged at least approximately parallel to one another.

Approximately 90% of the fibers of the fiber material 106 or more, in particular approximately 95% of the fibers of the fiber material 106 or more, for example approximately 98% of the fibers of the fiber material 106 or more, are preferably arranged at least approximately parallel to one another.

It can be advantageous if the fibers of the fiber material 106 in the flat material 100 are arranged at least approximately parallel to a main extension plane of the flat material 100.

The flat material 100 can preferably be wound up, in particular in the form of a single layer. The flat material 100 can preferably be wound up with a thickness in a range from approximately 0.1 mm to approximately 0.6 mm.

The thickness of the flat material 100 is preferably defined perpendicular to the main extension plane thereof, in particular in an unwound state.

It can be favorable if the flat material 10 is a band material 108 and/or a tape material 110.

A thickness of the flat material 100 perpendicular to the main extension plane thereof is preferably approximately 5 mm or less, in particular approximately 4 mm or less, for example approximately 3 mm or less.

The thickness of the flat material 100 perpendicular to the main extension plane thereof is preferably approximately 0.5 mm or more, in particular approximately 1 mm or more, for example approximately 1.2 mm or more.

A proportion of the fiber material 106 to the flat material 100 is preferably approximately 70 wt. % or more, in particular approximately 75 wt. % or more, for example approximately 78 wt. % or more, based on a total mass of the flat material 100.

It can be favorable if the proportion of the fiber material 106 to the flat material 100 is approximately 90 wt. % or less, in particular approximately 85 wt. % or less, for example approximately 80 wt. % or less, based on the total mass of flat material 100.

It can be advantageous if the proportion of the fiber material 106 to the flat material 100, based on a total volume of flat material 100, is approximately 50 vol. % or more, in particular approximately 55 vol. % or more, for example approximately 58 vol. % or more.

In particular, the proportion of the fiber material 106 to the flat material 100, based on the total volume of the flat material 100, is approximately 70 vol. % or less, in particular approximately 65 vol. % or less, for example approximately 62 vol. % or less.

Due in particular to the high proportion of the fiber material 106 to the flat material 100, a modulus of elasticity of the flat material 100 is preferably approximately 35 GPa or more, in particular approximately 36 GPa or more.

The modulus of elasticity of the flat material 100 is in particular approximately 46 GPa or less, in particular approximately 45 GPa or less.

The modulus of elasticity of the flat material 100 is preferably determined at approximately 20° C. and/or in the direction of the fibers.

It can be advantageous if the fiber material 106 comprises glass fibers or is made of glass fibers.

By using the fiber material 106 in the flat material 100, forces acting on the flat material 100 can be redirected in particular from the fibers of the fiber material 106 into the thermoplastic polymer matrix material 104 or vice versa.

In particular, the adhesion of the thermoplastic polymer material 102 or of the thermoplastic polymer matrix material 104 to the fiber material 106 is optimized.

The flat material 100 preferably forms a stabilization and/or protective material.

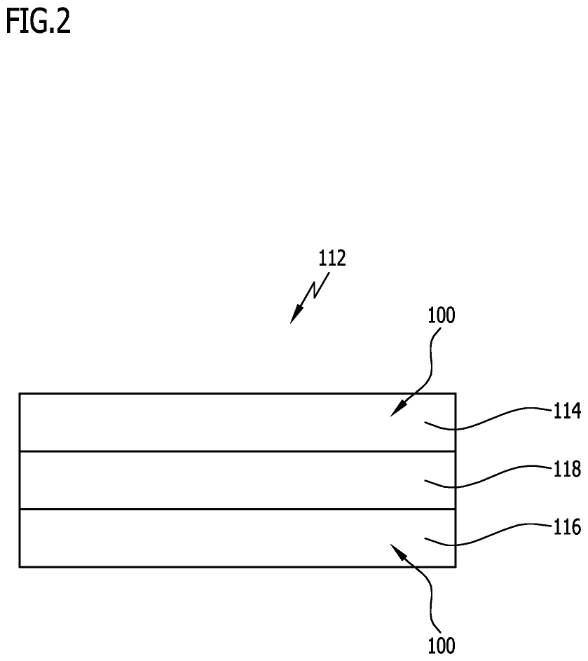

As can be seen in particular in FIG. 2, the flat material 100 is preferably used in a sandwich material 112.

The sandwich material 112 preferably comprises a first layer element 114 and a second layer element 116.

The first layer element 114 preferably comprises a flat material 100 or is made of a flat material 100.

It can be favorable if the second layer element 116 comprises a flat material 100 or is made of a flat material 100.

The thickness of the first layer element 114 and/or the second layer element 116 preferably corresponds to a thickness described in connection with the flat material 100.

An intermediate layer 118 is preferably arranged between the first layer element 114 and the second layer element 116. The intermediate layer 118 is preferably integrally connected to the first layer element 114 and the second layer element 116.

The intermediate layer 118 is made of a metallic material, for example, or comprises a metallic material.

Preferably, the intermediate layer 118 comprises or is made of a fiber-reinforced polymer material as an alternative to a metallic material. A fiber content of the intermediate layer 118 is preferably lower than the fiber content of the flat material 100.

A polymer material that is compatible, similar or identical to the polymer matrix material 104 of the flat material 100 is preferably used as the polymer material.

In this way, recyclability can be given.

For example, short fibers are used for the intermediate layer 118. The short fibers preferably have an average length of approximately 40 mm to approximately 100 mm.

In embodiments in which the intermediate layer 118 is reinforced with short fibers, the intermediate layer 118 is produced, for example, in an injection molding process.

Additionally or alternatively, the polymer material 102 of the intermediate layer 118 comprises long fibers. The long fibers preferably have an average length of approximately 100 mm or more and/or approximately 999 mm or less.

In embodiments in which the intermediate layer 118 is reinforced with long fibers, the intermediate layer 118 is preferably formed using a compression molding process, such as a DLFT (direct long fiber thermoplastic) compression molding process.

Alternatively, the intermediate layer 118 can comprise or be made of a glass mat reinforced thermoplastic (GMT).

The sandwich material 112 is preferably used in vehicles, for example in load-bearing elements of a vehicle, and/or in electrochemical storage units 120.

The vehicle in which the sandwich material 112 is used is, for example, an electric vehicle and/or a gas vehicle and/or a fuel cell vehicle.

The sandwich material 112 preferably forms a bulletproof protective plate.

Because a flat material 100 having the described properties is used in the first layer element 114 and/or the second layer element 116, the first layer element 114 and/or the second layer element 116 can be made thicker than layer elements made of aluminum while the weight remains the same. This is due in particular to the lower density of the flat material 100 compared to aluminum.

The sandwich material 112 preferably has an increased structural rigidity compared to sandwich structures having layer elements made of aluminum, in particular due to a higher moment of resistance to bending.

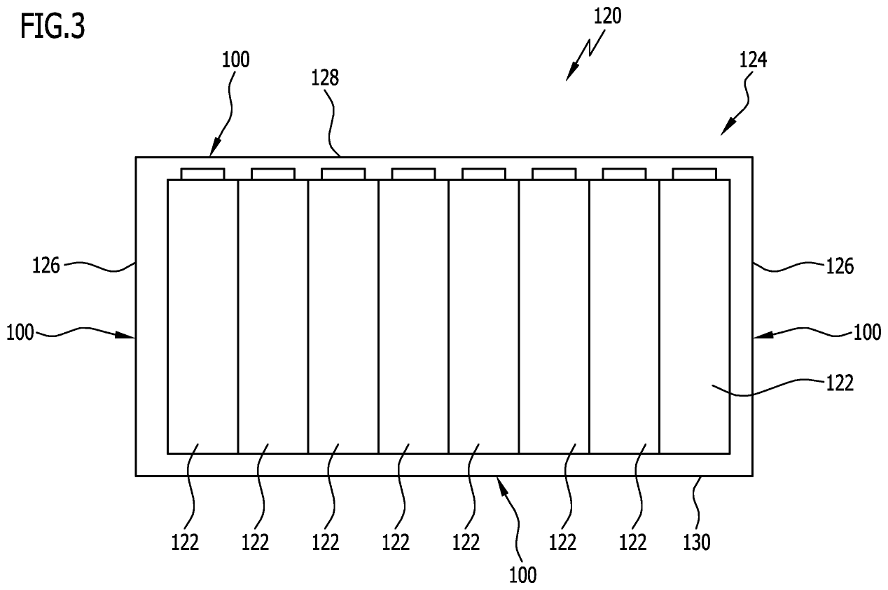

An electrochemical storage unit 120 is shown schematically in FIG. 3.

The electrochemical storage unit 120 is a battery module and/or an accumulator module, for example.

An electrochemical storage unit 120 preferably comprises one or more—in this case a plurality of—electrochemical cells 122. The electrochemical cells 122 are preferably received by a receiving element 124 of the electrochemical storage unit 120.

The receiving element 124 preferably serves to attach and/or stabilize the electrochemical cells 122.

The electrochemical cells 122 are preferably lithium-ion batteries and/or lithium-ion accumulators.

For example, the receiving element 124 forms a frame for the electrochemical cells 122 and/or a housing.

It can be advantageous if the receiving element 124 comprises four sidewalls 126 that surround the electrochemical cells 122 laterally and/or on four sides.

Openings formed by the sidewalls 126 are preferably closed, in particular in a fluid-tight manner, by a cover element 128 of the receiving element 124 on a side facing the connection elements of the electrochemical cells 122 and by a bottom wall 130 of the receiving element 124 on an opposite side.

It can be advantageous if the cover element 128 comprises a flat material 100 or is made of a flat material 100.

Additionally or alternatively, one or more sidewalls 126 of the receiving element 124 comprise a flat material 100 or are formed from a flat material 100.

Additionally or alternatively, the bottom wall 130 of the receiving element 124 comprises a flat material 100 or is formed from a flat material 100.

It can be provided that the flat material 100 is integrated into a sandwich material 112. In this case, reference is made to the description in connection with FIG. 2.

The flat material 100 preferably has high fire resistance.

Preferably, the flat material 100 does not have burn through in conjunction with structural failure in a fire test, such as an ECE180 fire test.

A temperature on an inner side of the flat material 100 is preferably not critical to underlying assemblies.

In the ECE180 fire test, a mixed accident of an internal combustion engine vehicle and/or a battery electric car and/or a plug-in hybrid vehicle and/or a hydrogen-powered vehicle is preferably simulated. In this case, fuel usually leaks and catches fire.

In the fire test, a fire pan is preferably filled with a fuel, for example premium-grade gasoline, and allowed to burn for approximately 60 seconds until a defined and/or constant flame temperature of approximately 700° C. to approximately 800° C. is reached.

A defined evacuation time of 130 seconds, during which the occupants of a vehicle can be rescued, is preferably established in the fire test.

After the flame temperature is set, the fire pan moves under a test plate and remains there for approximately 70 seconds.

A stone grate then moves in to form a chimney effect and remains under and/or near the test plate for a further 60 seconds.

A test plate is preferably installed as the bottom wall of a receiving element in the fire test. A battery box can be simulated in this way.

A frame of the receiving element is made of aluminum for the fire test, while a cover element is made of gypsum.

The test plate is preferably made of a sandwich material 112, the first layer element 114 and the second layer element 116 of which are made of a flat material 100.

The flat material 100 is made of a polypropylene material, for example, in which a fiber material 106 having a proportion of approximately 80 wt. %, based on the total mass of the flat material 100, is received. The fiber material 106 is preferably made of glass fibers.

A thickness of the first layer element 114 and of the second layer element 116 perpendicular to their respective main extension plane is preferably approximately 1.5 mm in each case.

In particular, the test plate for the fire test has dimensions of approximately 695 mm×approximately 695 mm.

FIG. 3 shows a temporal temperature profile of different regions.

The temperature in ° C. over the time tin seconds is plotted on the x-axis.

A temporal profile of the temperature of an inner side of the test plate facing an interior space of the receiving element and arranged away from the flames is shown as graph C (dash-dot line).

Graphs A (dashed line) and B (dotted line) show a temporal profile of the temperatures of the regions made of aluminum. From graphs A and B, it can be seen that the regions made of aluminum heat up to temperatures in excess of 350° C.

Graph C shows that the temperature on the inner side of the test plate also increases to a maximum of 99° C. after approximately 130 seconds.

In the fire test carried out, there is in particular only a loss of mass of approximately 14 g or less of the test plate made of the sandwich material 112.

This means in particular that the flat material 100 offers adequate protection and/or is stable even in the event of a fire.

Due to the high proportion of fiber material 106 to the flat material 100, preferably no and/or little oxygen can penetrate into deeper layers of the outer layer element, as a result of which the test plate has increased stability in particular.

The flat material 100 preferably has increased impact properties.

1. A flat material, in particular for use in sandwich materials in vehicles and/or electrochemical storage units, wherein the flat material comprises a thermoplastic polymer matrix material in which a fiber material is received, wherein the fiber material comprises fibers or is made of fibers that are arranged at least approximately parallel to one another, and the proportion of the fiber material to the flat material equals approximately 75 wt. % or more, based on a total mass of the flat material.

2. The flat material according to claim 1, wherein the thermoplastic polymer matrix material is made of a thermoplastic polymer material that has a melt flow index of approximately 400 (g/10 min) or more, in particular of approximately 700 (g/10 min) or more, in particular of approximately 1200 (g/10 min) or more.

3. The flat material according to claim 1, wherein the thermoplastic polymer matrix material and/or a thermoplastic polymer material from which the thermoplastic polymer matrix material is made is a polyolefin material, in particular a polypropylene material.

4. The flat material according to claim 1, wherein a proportion of the fiber material in the flat material is approximately 78 wt. % or more, in particular approximately 80 wt. % or more, based on the total mass of the flat material, and/or wherein a modulus of elasticity of the flat material is in a range of approximately 41 GPa to approximately 50 GPa, in particular in a range of approximately 44 GPa to approximately 47 GPa.

5. The flat material according to claim 1, wherein the fiber material comprises glass fibers or is made of glass fibers.

6. The flat material according to claim 1, wherein the fiber material is a continuous fiber material.

7. The flat material according to claim 1, wherein the flat material is made of the fiber material pre-impregnated with a polymer material, which is in particular a thermoplastic polymer material, wherein the fiber material is in particular completely impregnated with the polymer material.

8. A sandwich material, in particular for use as a load-bearing element in a vehicle and/or in a receiving element of an electrochemical storage unit, wherein the sandwich material has a first layer element, a second layer element and an intermediate layer arranged between the first layer element and the second layer element, and the first layer element and/or the second layer element comprises a flat material according to claim 1 or is formed therefrom.

9. An electrochemical storage unit, comprising one or more electrochemical cells and a receiving element for receiving and/or fastening the one or more electrochemical cells, wherein the receiving element comprises a flat material according to claim 1.

10. A method for producing a flat material, in particular a flat material according to claim 1, wherein the method comprises the following:
impregnating a fiber material that comprises fibers or is made of fibers that are arranged at least approximately parallel to one another with a thermoplastic polymer material, wherein a proportion of the fiber material to a resulting flat material is approximately 75 wt. % or more, based on a total mass of the flat material.
